(19) United States
(12) Patent Application Publication
(10) Pub. No.: US 2012/0324780 A1
(43) Pub. Date: Dec. 27, 2012

(54) Insect Monitoring System

(75) Inventor: David James, Fort Collins, CO (US)

(73) Assignee: Nuvenco IP, LLC

(21) Appl. No.: 13/582,406

(22) PCT Filed: Mar. 4, 2011
(86) PCT No.: PCT/US2011/000418

§ 371 Date: Aug. 31, 2012

Related U.S. Application Data
(60) Provisional application No. 61/339,517, filed on Mar. 5, 2010.

(51) Int. Cl. A01M 1/10; A01M 1/00

(52) U.S. Cl. 43/107; 43/58

(57) ABSTRACT

Generally, an insect monitor which delivers an insect attractant in the form of one or more gases proximate an enclosure in concentration effective to attract insects to an insect trap within the enclosure to monitor an area for insects. Specifically, an insect monitor which delivers a mixture of gases produced from a fermentation broth in a vessel proximate an enclosure to attract insects to an insect trap within the enclosure to monitor an area for insects.

This application is the United States National Stage of International Patent Corporation Treaty Patent Application No. PCT/US2011/000418, Mar. 4, 2011, which claims the benefit of U.S. Provisional Patent Application No. 61/339,517, filed Mar. 5, 2010, each hereby incorporated by reference herein.

### I. BACKGROUND

Generally, an insect monitor which delivers an insect attractant in the form of one or more gases proximate an enclosure in a concentration effective to attract insects to an insect trap within the enclosure to monitor an area for insects. Specifically, an insect monitor which delivers a mixture of gases produced from a fermentation broth in a vessel to an enclosure in sufficient concentration to attract insects to an insect trap within the enclosure.

Determination of insect infestation and the effectiveness of insect eradication may involve insect monitoring. Insect monitoring may utilize insect traps within the monitored area. Insect monitoring may continue for a period of several days in a monitored area to determine the extent, if any, of insect infestation or to ensure that re-infestation has not occurred. If additional insects are trapped, eradication procedures are often repeated as necessary until no insects are subsequently trapped in the monitored area.

Conventional apparatus and methods utilized in insect monitoring for entrapment of insects may not include an attractant to induce insects in a monitored area into the insect monitor. Additionally, as to those insect monitors which do include an attractant, the amount of attractant or the period of time over which the attractant is produced or the period of time over which the attractant is effective may be insufficient to ensure successful monitoring of insects in the monitored area. Moreover, the attractant may be limited a single type of gas such as carbon dioxide which may have a limited effect on attracting certain species of insects.

The instant invention provides an insect monitor which provides an insect attractant source which can deliver an effective amount of insect attractant proximate an enclosure including an insect trap over sufficient a period of time to monitor an area for insects.

### II. SUMMARY OF THE INVENTION

Accordingly, a broad object of the invention can be to provide an insect monitor which includes an insect attractant source which can produce substantially one gas or a mixture of gases capable of attracting insects such a gas or mixture of gases delivered proximate an enclosure.

Another broad object of the invention can be to provide an insect attractant source in the form of a fermentation broth which produces an insect attractant in the form of a gas or a mixture of gases over sufficient period of time and in an amount effective to attract insects in a monitored area.

Another broad object of the invention can be to fluidicly couple the insect attractant within a remote vessel to an enclosure configured to disperse the insect attractant proximate or about an insect trap in a manner capable of attracting insects into the insect trap to monitor an area.

Naturally, further objects of the invention may be disclosed throughout other areas of the specification, drawings, photographs, and claims.

### III. A BRIEF DESCRIPTION OF THE DRAWINGS

FIG. 1 is a perspective view of a particular embodiment of the invention.

FIG. 2 is an exploded view of the particular embodiment of the invention shown in FIG. 1.

FIG. 3 a cross section 3-3 of the particular embodiment of the invention shown in FIG. 1.

### IV. DETAILED DESCRIPTION OF THE PREFERRED EMBODIMENTS

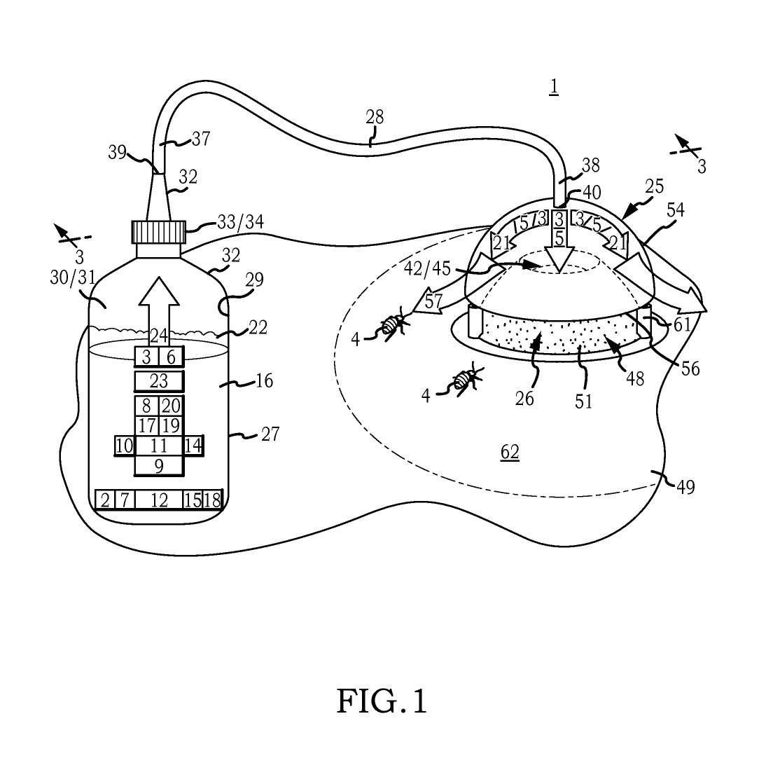

Referring to FIGS. 1-3, embodiments of the insect monitor (1) can include an insect attractant source (2) capable of emitting an amount of insect attractant (3) in a concentration (5) effective to attract insects (4).

The insect attractant source (2) as to particular embodiments can be an amount of dry ice, or liquefied or pressurized carbon dioxide, or a mixture of gases having a partial pressure of carbon dioxide (6) which can emit or deliver an amount of carbon dioxide gas (6) at a concentration effective to attract insects.

As to particular embodiments, the insect attractant source (2) can be an amount of degradable material (7) or combination of degradable materials. As used herein “degrade” means to react, alter, break down, disassociate, evaporate, change phases or otherwise to emit an amount of insect attractant (3). The emitted amount of insect attractant (3) can take the form of an amount of carbon dioxide (6), a mixture of gases containing a partial pressure of carbon dioxide (6) or other partial pressure(s) of a gas(es) which can attract insects (4) other than carbon dioxide (6). As non-limiting examples, embodiments of the insect attractant source (2) can be one or more of an amount of ammonium bicarbonate, potassium bicarbonate, citric acid combined with sodium bicarbonate, acetic acid combined with sodium bicarbonate, or combinations thereof which can be further combined with an amount of solvent (8) such as an amount of water.

As to particular embodiments, the insect attractant source (2) can further include an enzyme (9) or microorganism (10) which acts to degrade or alter the insect attractant source (2) to emit the amount of insect attractant (3) in a concentration effective to attract insects. As a non-limiting example, the enzyme can be one or more of amylase, pepsin, sucrase, maltase, isomaltase, lactase, erepsin, pyruvate decarboxylase, 2-oxo-acid carboxylase, alpha-ketoacid carboxylase, pyruvic decarboxylase, pyruvate dehydrogenase, and pyruvate oxidase.

The microorganism (10) can be a bacteria (11) capable of converting a carbohydrate (12) or other organic compounds) to an amount alcohol (13) and an amount of carbon dioxide (6) and other gases having a partial pressure of carbon dioxide (6) or other partial pressures of gases which attract insects. The bacteria (11) can be one or more of a Bacillus, a Lactobacillus, an Escherichia, a Salmonella, and a Streptococcus; however, the invention is not so limited and other bacteria (11) capable of converting an amount of carbohydrate (12) (or other organic compounds) to release an amount of carbon dioxide (6) or other gas which attracts insects (4) can be utilized. The amount of carbohydrate (12) can be an isolated substantially pure carbohydrate. As non-limiting examples, a polysaccharide, a mono-polysaccharides, a di-polysaccharides, a tri-polysaccharide, sucrose, glucose, fructose, arabinose, maltose, galactose, sorbose, dextrose, mannose, levoglucosan, lactose, ribose, xylose, talose, chelose, lyxose, gulose, allose, idose, cellobiose, tagatose, rhamnose, myo-inositol, psicose, maltitriose, raffinose, trehalose, melibiose, or the like, and combinations thereof.

As to particular embodiments, the microorganism (10) can be an amount of yeast (14) (or a combination of yeast (14) and bacteria (11) as above described) which can degrade an insect attractant source (2) in the form of a fermentable material (15). Non-limiting examples of the amount of yeast (14) include: baker's yeast, distiller's yeast, brewer's yeast, Saccharomyces cerevisiae, or the like, and combinations thereof Baker's yeast includes strains of yeast commonly used as a leavening agent in baking bread and bakery products, where it converts the fermentable sugars present in the dough into carbon dioxide (6) and ethanol (13). Baker's yeast can be the species Saccharomyces cerevisiae. Distillers yeast can be a combination of yeasts selected for their tolerance of higher alcohol contents and the speed in which they can ferment a given amount of sugar. Brewer's yeast is typically of the species Saccharomyces cerevisiae used to ferment grains into beer. The amount of yeast (14) can be utilized to act on the fermentable material (15) to emit an amount of insect attractant (3) in a concentration (5) effective to attract insects (4). Action of the amount of yeast (14) (whether or not including bacteria) on the fermentable material (15) can emit an amount of insect attractant (2) in the form of an amount of carbon dioxide (6), a mixture of gases containing a partial pressure of carbon dioxide (6), or other partial pressure(s) of gas(es) which attract insects. As non-limiting examples, action of an amount of yeast (14) on an amount of fermentable material (15) can emit an amount of insect attractant (2) as one or more of: carbon dioxide (6), an aldehyde, an ethyl acetate, an ester, a fatty acid, a fusel oil, hydrogen sulfide, a ketone, hydrogen, a mercaptan, or the like. The fermentable material (14) can as non-limiting examples be an amount of: cellulose, saw dust, powered milk, honey, molasses, distiller's grain, malted grains, grains, wheat, barley, corn, rice, starch, glycogen, and combinations thereof. Additionally, the fermentable material (14) can be provided as an isolated substantially pure carbohydrate (12) as above-described.

As to particular embodiments, the insect attractant source (2) can be a fermentation broth (16) generated by combining one or more of an amount of yeast (14), or an amount of bacteria (11), or an amount of an enzyme (9) and a fermentable material (15) which emits an amount of an insect attractant (3) in a concentration (5) effective to attract insects (4), as above-described.

As to particular embodiments, the fermentation broth (16) can further include a pH adjustment material (17) added in sufficient amount to maintain the fermentation broth at pH in a range of about 3.5 to about 8.0 pH depending upon the carbohydrates (12), the enzymes (9) or the microorganisms (10) utilized in the fermentation broth (16). As non-limiting examples, the pH adjustment material can be one or more of: a buffer, an amount of sodium bicarbonate, 3-(N-morpholino)propanesulfonic acid (“MOPS”), potassium bicarbonate, calcium carbonate, citrate buffer, (4-(2-hydroxyethyl)-1-piperazineethanesulfonic acid) (“HEPES”), or the like.

While particular examples of insect attractant sources (2) are provided below; the invention is not so limited, and a numerous and wide variety of insect attractant sources (2) such as of carbon dioxide gas (6), materials that emit carbon dioxide gas (6), degradable materials (7), fermentable materials (15), carbohydrates or sugars (12), proteins, amino acids, nucleic acids, and other organic compounds can emit or be acted upon by a correspondingly numerous and wide variety of enzymes (9) or microorganisms (7) to emit an amount of carbon dioxide gas (6), a mixture of gases including a partial pressure of carbon dioxide (6) (the mixture of gases as to certain insects being a more effective insect attractant (2) than carbon dioxide (6) alone), volatile organic compounds, or the like in concentrations (5) effective to attract insects (4).

As one non-limiting illustrative example, the insect attractant source (2) can include an amount of sucrose (18), an amount of yeast (14) (Saccharomyces cerevisiae), and an amount of sodium bicarbonate (19) which can be mixed in an amount of water (20) which emits, or generates a fermentation broth (16) which emits, an amount of insect attractant (2) in a concentration (5) effective to attract insects (4).

Accordingly, a suitable insect attractant source (2) can be produced by providing an amount of sucrose (CAS #57-50-1) (18), an amount of yeast (14), for example baker's yeast (CAS #68876-77-7), and an amount of sodium bicarbonate (CAS #144-55-8) (19). The amount of sucrose (18), the amount of yeast (14) and the amount of sodium bicarbonate (19) can be added to an amount of water (CAS #7789-20-0) (20) to generate the fermentation broth (16). The amount of sucrose (18) can be adjusted within a range which provides the least amount of sucrose (18) sufficient to generate the concentration of carbon dioxide gas (CAS #124-38-9) (6) effective to attract insects (4) over a period of time (21) (which can be a pre-selected period of time) and the greatest amount of sucrose (18) that can be dissolved in the amount of water (20). Similarly, the amount of yeast (14) can be adjusted in a range of an amount of yeast (14) sufficient to generate the concentration (5) of carbon dioxide (6) (or other gases as above described) effective to attract insects (4) continuously over a the period of time (21) and less than the amount of yeast (14) that results in an excessive amount of froth (22) over the fermentation broth (16) (bubbles caused in fluids by fermentation). The amount of sodium bicarbonate (19) can be adjusted to result in a pH of the resulting fermentation broth (16) in a range of about 3.5 and about 8.0 over the period of time (21). The combination of sucrose (18), yeast 14), and sodium bicarbonate (19) in water (20) can incubate at a temperature (23) in a range which produces an amount of carbon dioxide gas (6) sufficient to attract insects (4) and a temperature (23) less than that which kills the amount of yeast (14).

Particular non-limiting examples of an insect attractant source (2) are set out below in Tables 1-3. The amount of water (20) can be added to result in the corresponding fermentation broth (16).

TABLE 1

| Raw Material | Grams/Milliliters | |
|---|---|---|
| Sucrose | 53 | grams |
| Yeast | 0.6 | grams |
| Sodium Bicarbonate | 2.5 | grams |
| Water | 235 | milliliters |

Understandably, the amounts of the raw materials can be increased or decreased in proportional or in disproportional relation to one another each within the ranges shown in Table 2 to produce a greater or lesser amount of insect attractant source (2) or volume of fermentation broth (16) to produce a greater or lesser amount of insect attractant (3) depending upon the application.

TABLE 2

| | | |
|---|---|---|
| Sucrose | 0.6-265.0 | grams |
| Yeast | 0.5-12.0 | grams |
| Sodium Bicarbonate | 0.5-12.0 | grams |
| Water | 47-1175 | milliliters |

Additionally, even if the volume of fermentation broth (15) remains fixed the amounts of raw materials can be increased or decreased in relation to one another within certain ranges to produce a numerous and wide variety of fermentation broths (15), as shown in the non-limiting example of Table 3.

TABLE 3

| | | |
|---|---|---|
| Sucrose | 10.0-125 | grams |
| Yeast | 0.2-6.0 | grams |
| Sodium Bicarbonate | 0.5-10.0 | grams |
| Water | 235 | milliliters |

While particular examples of an insect attractant source (2) and fermentation broth (16) are provided in Tables 1-3, the invention is not so limited, and embodiments can include one or more of the insect attractant sources (2) described herein.

Certain embodiments of the insect attractant source (2) can consist essentially of or consist of an amount of yeast (14), an amount of carbohydrate (12), and an amount of pH adjustment material (17), each sufficient to allow emission of a concentration (5) of insect attractant (2) effective in attracting insects (4).

As to particular embodiments, the amount of insect attractant (3) can be emitted continuously over a relatively short period of time (21). As one example, the combination of citric acid combined with sodium bicarbonate as above described can emit an amount of insect attractant (3) continuously over a period of time (21) of between about 5 minutes and about 60 minutes.

As to other particular embodiments, the amount of insect attractant (2) can be emitted for over a longer period of time (21). As one example, ammonium bicarbonate in water can emit an amount of insect attractant continuously over a period of time of between about 5 hours and about 24 hours.

However, because certain insects (4) that have fed may not be attracted to any amount of insect attractant (3), there is a need for an insect attractant source (2) which can continuously emit an amount of insect attractant (3) at a concentration (5) sufficient to attract insects (4) for a period of time (21) which allows insects (4) that have fed to recover the ability to sense the amount of insect attractant (3). As non-limiting examples, the insect attractant sources (2) of Tables 1-3 including the fermentation broths (16) can emit an amount of insect attractant (3) continuously over a period of time (21) of between about 1 hour and about 168 hours, and the amount of raw material can be selected to provide embodiments which emit an amount insect attractant (2) continuously over a period of time (21) within that range such as: not less than 1 day, not less than 2 days, not less than 3 days, not less than 4 days, not less than 5 days or such as nearly 0 minutes and about 24 hours, about 12 hours and about 36 hours, about 24 hours and about 48 hours, about 36 hours and about 60 hours, about 48 hours and about 72 hours, about 60 hours and about 84 hours, about 72 hours and about 96 hours, about 84 hours and about 108 hours, about 96 hours and about 120 hours, about 108 hours and about 132 hours, about 120 hours and about 144 hours, about 132 hours and about 156 hours, about 144 hours and about 168 hours, and about 156 hours and about 168 hours.

However, the invention is not so limited, and the period of time (21) can as to certain applications be as little as one hour and in regard to other applications can be several days. As to certain applications, in which the presence or absence of insects (4) is to be determined by monitoring, it may be necessary to provide an insect attractant source (2) which can continuously emit an amount of insect attractant (3) over a period of between one day and seven days or longer. As to embodiments of the insect attractant source (2) in the form of a fermentation broth (16), the insect attractant generation rate (24) and the period of time (21) over which the amount of insect attractant (3) can be produced can be adjusted by an increase or decrease in the raw materials over the wide ranges shown for example in Table 2. Additionally, the insect attractant generation rate (24) can be adjusted to achieve a concentration (5) effective to attract insects (4) over the entire period of time (21). The insect attractant generation rate (24) can be adjusted dependent upon the embodiment of the insect attractant source (2) or the configuration of the insect monitor (1) and the species of insect (4) and other parameters, as further described below.

Again referring to FIGS. 1-3, as to particular embodiments of the insect monitor (1) and the method of producing and using monitoring insects can further include an enclosure (25) having at least one opening (26) to allow ingress of insects (4), a vessel (27) located remote from said enclosure (25); and a conduit (28) which can fluidicly couple the vessel (27) to the enclosure (25). The term remote means separate, not as one piece but as separate pieces. For example, the embodiment shown in FIGS. 1-3 shows the vessel (27) being remote from the enclosure (25).

As to these particular embodiments, the insect attractant source (2) can be contained within the vessel (27). The vessel (27) can have an internal surface (29) which defines an inside space (30) having dimensional relations sufficient to contain the amount of insect attractant source (2). With respect to the non-limiting example in which the insect attractant source (2) comprises a fermentation broth (16), the vessel (27) can have a wide range of configurations which provide sufficient inside space (30) to contain the amount of fermentation broth (16) produced in accordance with the above description and the amount of froth (22) produced during fermentation. A vessel (27) suitable for a wide range of applications can have an inside space (30) sufficient to contain between 100 milliliters and 250 milliliters of fermentation broth (16) and the amount of froth (22) produced from the fermentation process. As to certain embodiments, the vessel (27) can be generally cylindrical having a diameter of about 7 centimeters and having a height of about 13 centimeters which affords an inside space (30) having a volume of about 500 mL. Embodiments of the insect attractant source (2) such as those of Tables 1 and 3 can be located in such a vessel (27) affording a head space (31) above the fermentation broth (16) which receives the amount of insect attractant (3) emitted by the fermentation broth (16) as a gas (32) or partial pressure(s) of a mixture of gases. The vessel (27) can provide an amount of taper (32) such that all or a portion of the vessel (27) tapers inwardly approaching the conduit (28) which fluidicly couples the vessel (27) to the enclosure (25), as shown in FIG. 1. The amount of taper (32) in the vessel (27) can be adjusted to generate, promote or assist in transfer of the amount of insect attractant (3) between the vessel (27) and the enclosure (25).

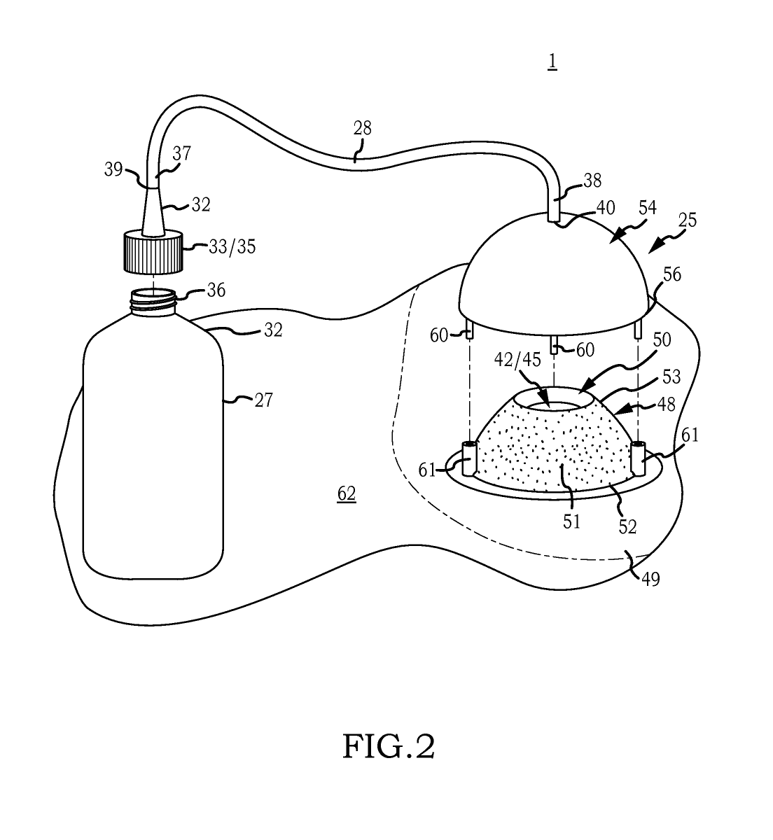

The vessel (27) can further include a releaseably sealable closure (33). The releasably sealable closure (33) can operate between a closed condition (34) (see FIG. 1) and an open condition (35) (see FIG. 2) to releasably seal the vessel (27). While the closure (33) and vessel (27) shown in FIGS. 1-3 provides rotationally mateable threads (36) which allow releasably sealable engagement of the closure (33) with the vessel (27); the invention is not so limited, and the closure element (33) can releasably seal with the vessel (27) through mateable parts which compression fit, snap together, forcibly urge against each other by operation of mechanical fasteners, or the like. The releasably sealable closure (33) can further generally taper inwardly approaching the conduit (28) which fluidicly couples the vessel (27) to the enclosure (25). The amount of taper (32) in the closure (33) can be adjusted to generate, promote or assist in transfer of the amount of insect attractant (3) between the vessel (27) and the enclosure (25). The amount of insect attractant (3) can be transferred through the conduit (28) from the vessel (27) to the inside of the enclosure (25) in a concentration (5) effective in attracting insects (4). However, this particular example is not intended to be limiting but rather illustrative of the numerous and wide range of vessels (27) of lesser or greater inside space (30) that can be utilized in embodiments of the invention.

With respect to an insect attractant source (2) in the form of a compressed carbon dioxide gas (6), the vessel (27) can be take the form of a gas cylinder (37) and with respect to the insect attractant source (2) in the form of dry ice (37) the vessel (27) can have sufficient dimensional relations to contain one or more pieces of dry ice (37). Understandably, the constructional form and dimensional relations of the vessel (27) can be adapted to provide or contain a numerous and wide varieties of insect attractant sources (2).

Again referring to FIGS. 1-3, embodiments of the invention can further include an enclosure (25) having at least one opening (26) to allow ingress of insects (4). The enclosure (25) can be fluidicly coupled to the vessel (27) by the conduit (28). The amount of insect attractant (3) emitted by the insect attractant source (2) within the vessel (27) can be transferred through the conduit (28) to the inside of the enclosure (25). The enclosure (25) whether in the constructional form of one piece or a plurality of pieces can provide a configuration capable of distributing the amount of insect attractant (3) in a concentration (5) about the enclosure (25) effective to attract insects (4) toward the at least one opening (26).

The conduit (28), as one non-limiting example, can be a flexible tube having a first end (37) and a second end (38). The first end (37) can be connected to a vessel outlet element (39) of the vessel (27). The vessel outlet element (39) can have a location which fluidicly couples the headspace (31) within the vessel (27) to the first end (37) of the flexible tube. The second end (38) can be connected to an enclosure inlet (40) which fluidicly couples the inside space (41) of the enclosure (25). The conduit (28) can be of a numerous and wide variety of materials including metals such as copper or stainless steel or plastics such as polypropylene, polyethylene, nylon, fluorocarbon, or the like.

Again referring to FIGS. 1-3, the enclosure (25) can further include an insect trap (42). The insect trap (42) can have a configuration which allows ingress of an insect (4) but does not allow egress of the insect (4) from the insect trap (42).

Particular embodiments of the insect trap (42) can provide a trap surface (43) on which an amount of trap material (44) can be located. The trap material (44) can be sufficiently adherent or sticky in relation to the trap surface (43) and to an insect (4) that upon contact of the insect (4) with the trap material (43) the insect (4) cannot release from the trap material (43) or egress from the insect trap (42). As to these particular embodiments of the invention, the trap material (44) can be an amount of oil such as motor oil or vegetable oil, petroleum jelly, rubber cement, or the like; however, the invention is not so limited.

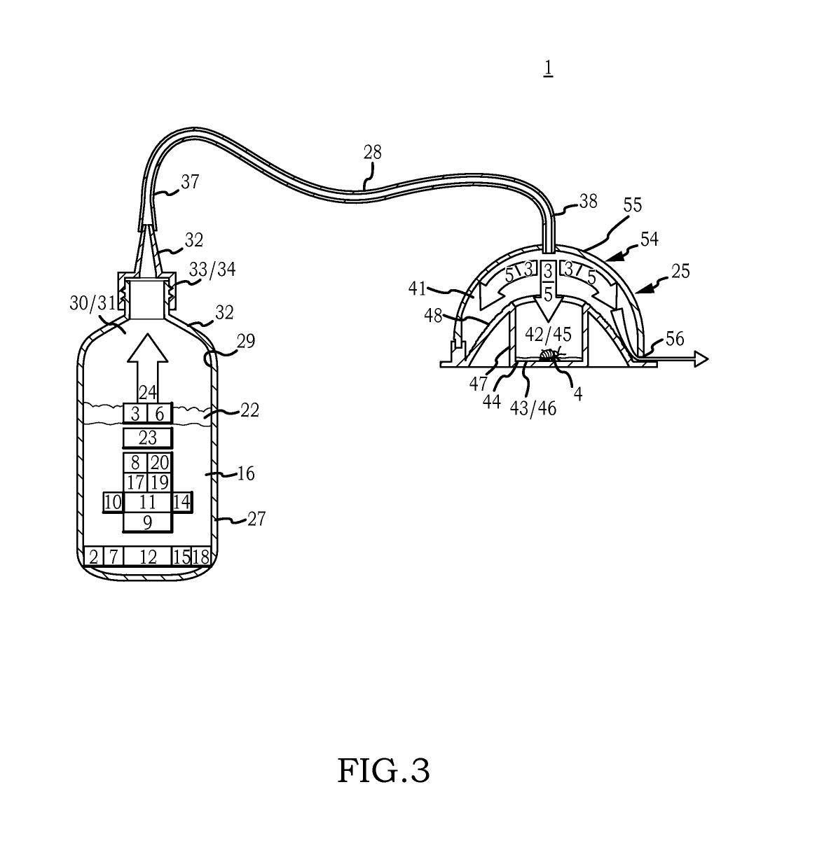

Particular embodiments of the insect trap (42) can have a configuration which provides a pit trap (45). The pit trap (45) can provide a bottom (46) surrounded by side walls (47). The side walls (47) in relation to the bottom (46) can have a configuration which does not allow egress of insects (4) from within the pit trap (45). As shown in FIG. 3, the pit trap (45) can be configured as a generally circular bottom (46) surrounded by a cylindrical side wall (47). The height of the pit trap (45) (for example height of the cylindrical side wall (47)) can be sufficient to prevent egress of an insect (4) from the pit trap (45). The side wall (47) can have a surface sufficiently smooth to impede movement of the insect (4) to an extent that prevents egress from the pit trap (45). An amount of trap material (44) as above described can be further included proximate or on the bottom (46) to further impede the movement of insects (4) from the pit trap (45). Understandably, the configuration, dimensional relations, surface texture, trap material can each be adjusted relative to the each other to provide a pit trap (45) from which insects (4) cannot egress.

Now referring primarily to FIGS. 2 and 3, the insect trap (42) or pit trap (45) can further provide ramp (48) configured to allow insects (4) to move between a support surface (49) on which the enclosure (25) has a location and a pit trap opening (50) of the pit trap (45). The surface of the ramp (48) can have a sufficient amount of texture (51) to allow movement of insect(s) (4) over the ramp (48). While the ramp (48) shown in FIGS. 2 and 3 entirely surrounds a generally cylindrical pit trap (45) and provides an amount of curvature (52) over the ascent of the ramp (48); the invention is not so limited, and the ramp (48) can be configured generally as a truncated cone having a greater diameter end (52) configured to engage the support surface (49) and a lesser diameter end (53) which surrounds the pit trap opening (50), or any configuration, dimensional relation, surface texture, and the like which allows insects (4) to ascend the ramp (48) and ingress the pit trap opening (50) of the pit trap (45).

Again referring to FIGS. 1-3, embodiments of the enclosure (25) can further provide an insect attractant distribution element (54). The insect attractant distribution element (54) can provide the enclosure inlet (40) which couples to the conduit (28) to allow transfer of the amount of insect attractant (3) from the vessel (27) to the inside space (41) of the enclosure (25). As to particular embodiments, the insect attractant distribution element (54) can have a generally convex internal surface (55) disposed a distance above the insect trap (42 which terminates in an edge (56) can be disposed a distance above the insect trap (42), the ramp (48) or the support surface (49) on which the enclosure (25) has a location. The distance between the edge (56) in relation to the insect trap (42), the ramp (48) or the support surface (49) can provide the at least one opening (26) which allows ingress of said insects (4) into the enclosure (25).

The configuration of the insect attractant distribution element (54) can distribute the amount of insect attractant (3) proximate the insect trap (42) and about the enclosure (25) in a concentration (5) sufficient to attract insects (4) to ingress the enclosure (25) through the at least one opening (26). The insect attractant distribution element (54) configured with a generally convex internal surface (55) terminating in an edge (56) can provide an embodiment configured to nearly engage the edge (56) with the support surface (49) surrounding the insect trap (42) (thereby the insect distribution element (54) disposed in relation to the insect trap (42) can provide an embodiment of the enclosure (25)) or be disposed a distance above the support surface (49) of between about 0.26 centimeters and about 1.0 centimeters to distribute an amount of insect attractant (3) about the enclosure (25) sufficient in concentration (5) to attract insects (4) toward said at least one opening (26) of the enclosure (25) and retain sufficient concentration of the insect attractant (3) within the enclosure (25) to induce an insect (4) to move toward the insect trap (42). The insect attractant distribution element (54) configured as above described can generate a concentration gradient (57) of the insect attractant (3) increasing in concentration (5) approaching the insect trap (42). Particular embodiments of the insect attractant distribution element (54) terminate in an edge (56) at a distance of about 0.5 centimeters above the support surface (49). As shown in FIGS. 1-3, certain non-limiting embodiments of the insect attractant distribution element (54) can provide a generally hemispherical configuration with the internal volume of the hemisphere generally centered at a distance over the insect trap (42); however, the invention is not so limited, and the insect attractant distribution element (54) can be of any configuration which allows sufficient insect attractant (3) to collect about the insect trap (42) to lure insects (4) to the insect trap (42), such as a cube, a cone, a rectangular prism, a cylinder, a pyramid, an ellipsoid, or the like.

Regardless of the configuration of the insect attractant distribution element (54) the internal surfaces (58) can be disposed in opposed relation to the external surfaces (59) of insect trap (42) to produce the enclosure (25) with the opening (26) between the opposed surfaces which allows movement of an insect (4) toward the insect trap (42). The conduit (28) through which the amount of insect attractant (3) flows can have the second end (38) connected to the enclosure inlet (40) of the insect attractant distribution element (54) at any location even though certain embodiments may locate the enclosure inlet (40) centrally on the external surface of the insect attractant distribution element (54) to allow a greater evenness of distribution of the insect attractant (3) in relation to or about the insect trap (42) or enclosure (25).

Now referring primarily to FIG. 2, certain embodiments of the enclosure (25) can assemble in releasable fixed relation by sliding engagement of guide elements (60) coupled to the insect attractant distribution element (54) into corresponding guide receiving elements (61) coupled to the insect trap (42); however, the invention is not so limited, and any manner or releasable mated engagement of the insect attractant distribution element (54) with the insect trap (42) can be utilized to produce a particular embodiment of the enclosure (25).

For the purposes of this invention, the term “insect” includes all insects and without limitation to the forgoing one or more of insects ( ) such as bed bugs, powder post beetles, moths, roaches, termites, fleas, wasps, bees, cicadas, ants, lice, head lice, mites, grain beetles, flour beetles, fire ants, mosquitoes, leafhoppers, plant hoppers, ticks, flies, or the like, and can further include non-insect species such as spiders, ticks, centipedes, or the like.

Again referring to FIGS. 1-3, a particular method of using the insect monitor (1) can include the step of providing an enclosure (25) and the further step of delivering an amount of insect attractant (3) proximate or about the enclosure (25) in a concentration (5) effective in attracting insects (4) toward the enclosure (25). In a further step, an insect trap (42) can be provided which includes one or more of an amount of trap material (44) applied to a trap surface (43) and a pit trap (45). The method can further include the step of providing an insect attractant source (2) and in particular the insect attractant source (2) can be provided from the group of dry ice, compressed carbon dioxide gas (6), a degradable material (7), an amount of an enzyme (9) or microorganism (10) which acts on a insect attractant source (2) to release the insect attractant (3), a fermentation broth (16), or combinations thereof. The method can further include the step of emitting an amount of insect attractant (3) from the insect attractant source (2) and the further step of distributing the amount of insect attractant (3) about the enclosure (25) in a concentration (5) effective to attract insects (4) toward at least one opening (26) in the enclosure (25) or into the insect trap (42). The method can further include the step of delivering an amount carbon dioxide gas (6) proximate to or about the enclosure (25) for a period of time (21) sufficient to determine whether insects (4) reside in the monitored area (62) and in particular the period of time (21) can be selected from the range of one hour to about seven days with embodiments of the invention represented by one hour increments in the range. The method can further include the step of adjusting the insect attractant source (3) to continuously deliver a sufficient amount of insect attractant (3) proximate or about the enclosure (25) over the entire period of time (21). As to those embodiments of the invention which provide a fermentation broth (16) as the insect attractant source (2), the method can further include the step of adjusting the proportion of the fermentable material (15), carbohydrate (12) or sugar to the amount of enzyme (9) or microorganisms (10) to continuously deliver a sufficient amount of insect attractant (3) about the enclosure (25) or the insect trap (42) over the entire period of time (21). The method can further include the steps of attracting insects (4) into the insect trap (42) with the amount of insect attractant (3) emitted by the insect attractant source (2) and the further step of trapping insects in the insect trap (42) within the period of time (21). The method can further include the step of observing trapped insects (4) within the insect trap (42) evidencing residence of insects (4) in the monitored area (62).

As can be easily understood from the foregoing, the basic concepts of the present invention may be embodied in a variety of ways. The invention involves numerous and varied embodiments of an insect monitor (1) and methods of making and using the insect monitor (1).

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of “insect trap” should be understood to encompass disclosure of the act of “trapping insects”—whether explicitly discussed or not—and, conversely, were there effectively disclosure of the act of “trapping insects”, such a disclosure should be understood to encompass disclosure of “an insect trap” and even a “means for trapping insects.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the insect monitors herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth in this specification are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An insect monitor, comprising;
an enclosure having at least one opening to allow ingress of insects;
a vessel located remote from said enclosure;
an insect attractant source located within said vessel which emits an amount of insect attractant; and
a conduit which fluidicly couples said vessel to said enclosure, said amount of insect attractant flowing through said conduit to said enclosure to establish a concentration about said enclosure effective in attracting said insects.

2. The insect monitor of claim 1, wherein said vessel has a body and a releasably sealable closure, wherein said body tapers generally inwardly approaching said releasably sealable closure.

3. The insect monitor of claim 2, wherein said releasably sealable cap generally tapers inwardly approaching said conduit which fluidicly couples said vessel to said enclosure.

4. The insect monitor of claim 1, wherein said enclosure further includes an insect trap which allows ingress and not egress of said insects from said enclosure.

5. The insect monitor of claim 4, wherein said insect trap comprises a pit trap having a bottom joined to a sidewall which allows ingress and not egress of said insects.

6. (canceled)

7. The insect monitor of claim 5, wherein said pit trap comprises a closed end cylinder having said sidewall of sufficient height and sufficiently smooth to prevent egress of said insects from within said pit trap.

8. The insect monitor of claim 4, further comprising an amount of trap material locatable within said insect trap, said trap material sufficiently adherent upon contact to prevent release of said insects.

9. The insect monitor of claim 5, wherein said enclosure further includes a ramp disposed in relation to said pit trap to allow ingress of said insects to a pit trap opening of said pit trap.

10. The insect monitor of claim 9, wherein said ramp surrounds said pit trap, said ramp having a first end configured to engage a support surface on which said enclosure has a location and a second end disposed at a height in relation to said pit trap opening which allows ingress of said insect into said pit trap.

11. The insect monitor of claim 10, wherein said ramp has a general configuration of a truncated cone having said first end of greater diameter and said second end of lesser diameter.

12. (canceled)

13. The insect monitor of claim 4, wherein said enclosure comprises an insect attractant distribution element disposed a distance above said insect trap, said insect attractant distribution element having a generally convex internal surface terminating in an edge disposed a distance above said support surface on which insect trap has a location to provide said at least one opening which allows ingress of said insects into said insect trap.

14. (canceled)

15. The insect monitor of claim 1, wherein said insect attractant source degrades to emit said amount of insect attractant.

16. (canceled)

17. The insect monitor of claim 15, wherein said insect attractant source degrades to emit said amount of insect attractant continuously over a period of time between about 1 hour and about 168 hours.

18-20. (canceled)

21. The insect monitor of claim 15, further comprising a microorganism which acts to degrade said insect attractant source to emit said amount of insect attractant.

22. The insect monitor of claim 21, wherein said microorganism which acts to degrades said insect attractant comprises a bacteria.

23. (canceled)

24. The insect monitor of claim 21, wherein said microoganism which acts to degrade said insect attractant comprises an amount of yeast and said insect attractant source comprises an amount of fermentable material.

25-26. (canceled)

27. The insect monitor of claim 24, wherein said microoganism comprises an amount of yeast and said insect attractant source comprises an amount of carbohydrate.

28. (canceled)

29. The insect monitor of claim 27, wherein said amount of insect attractant comprises at least one gas emitted from a mixture of said amount of yeast which degrades said amount of carbohydrate.

30-31. (canceled)

32. The insect monitor of claim 27, further comprising an amount of pH adjustment material mixed with said amount of yeast and said amount of carbohydrate.

33. (canceled)

34. The insect monitor of claim 1, wherein said insect attractant source comprises a fermentation broth which emits one or more gases which comprise said insect attractant.

35-77. (canceled)
